(19) United States
(12) Patent Application Publication
(10) Pub. No.: US 2009/0212589 A1
(43) Pub. Date: Aug. 27, 2009

(54) Outdoor Retractable Screen for Automobile

(76) Inventor: Eric Joseph Winstanley, Niagara Falls, NY (US)

Correspondence Address: Eric J. Winsanley, 4026 Barton St., Niagara Falls, NY, 14305, US

(21) Appl. No.: 12/359,334

(22) Filed: Jan. 25, 2009

Related U.S. Application Data
(60) Provisional application No. 61/030,999, filed on Feb. 24, 2008.

(51) Int. Cl. B60J 3/02

(52) U.S. Cl. 296/97.8

(57) ABSTRACT

The invention shields most unwanted debris and acts of mother-nature from entering an automobile's window. The invention is designed to be mounted on the exterior of any vehicle. The screen can be retracted to the stow-away position when not desirable, and can also be attached to the window when desired, very easily.

### CROSS REFERENCE TO RELATED APPLICATIONS

This application claims the benefit of U.S. Provisional Application No. 61/030,999 filed Feb. 24, 2008.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX Not Applicable

### BACKGROUND OF THE INVENTION

The invention described within is due to lack of protection from an open window on any automobile. Most automobile's that have a sun-roof or moon-roof in the open position allow any object to enter the vehicle without protection. As a vehicle is parked for a temporary amount of time, the sun-roof being open is a convenient way of allowing air to flow through your vehicle, however, an open window can allow falling sticks, leaves and other debris to enter the vehicle, causing the interior to become dirty and possibly causing tears. Also while the vehicle is in motion, many air currents can forcibly enter the window, causing unwanted use of the sunroof.

### BRIEF SUMMARY OF THE INVENTION

The invention is beneficial as it will shield many particles of matter, or other acts of mother-nature from entering an automobile's window when in the open position. Most sticks, leaves, dirt, rain drops, and air currents will be deflected due to the screen when in the open position. The retracting screen will make it very easy to stow the screen away when the user prefers not to use it.

### BRIEF DESCRIPTION OF THE SEVERAL VIEWS OF DRAWING

FIG. 1 shows the overall invention after assembly. The drawing shows how each part of the invention is positioned for its necessary use.

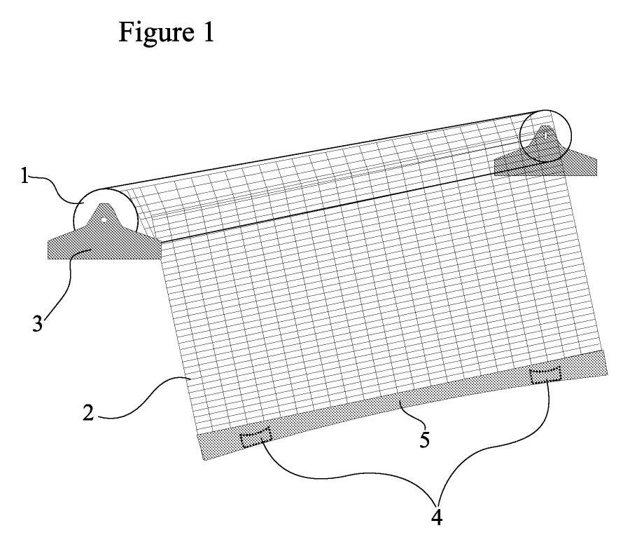

FIG. 2 shows the roller tube broken down into its various components.

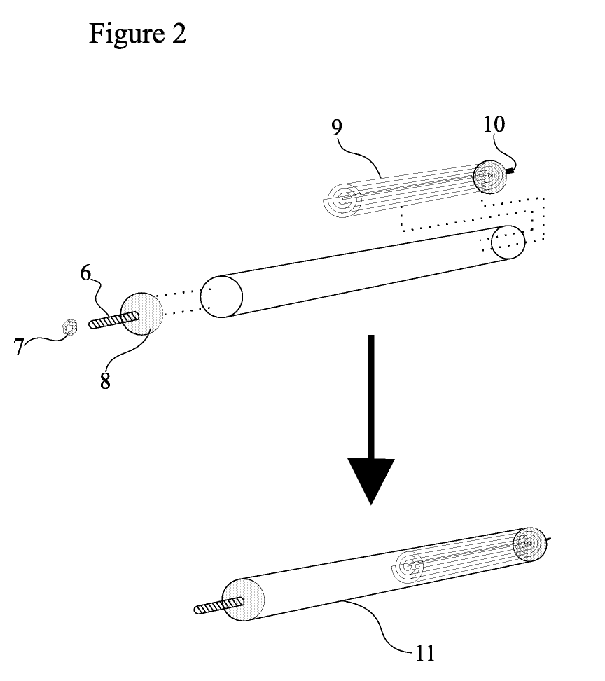

FIG. 3 shows detail of the mounting clips, and visualizes how the handle's can swing open or closed.

FIG. 4 details the mounting brackets, and how they attach to the vehicle as well as allow the spring assembly to retract.

FIG. 5 shows an automobile, and where the invention can be mounted in regards to any vehicle's window.

### DETAILED DESCRIPTION OF THE INVENTION:

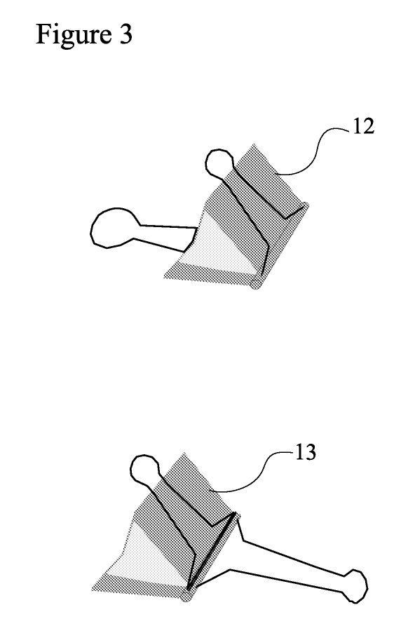

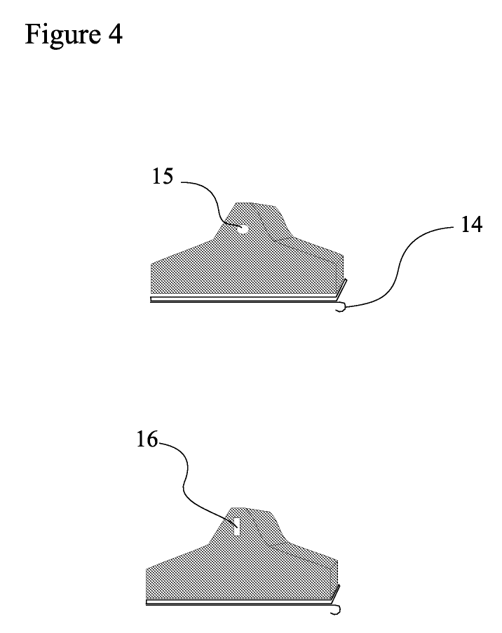

The invention described is a remedy for unwanted particles of matter and most acts of mother-nature from entering an automobile's window. The various components in manufacturing the retractable screen are already in today's world. Referring to figure's 1-5 the screen material 2 is attached to the roller tube 1 by using an adhesive such as glue, or tape. The spring assembly 9 helps the screen material 2 to be tensioned onto the roller tube 11. This tensioning system allows the screen material 2 to be wrapped around the roller tube 11 a minimum of two times, giving additional strength in regards to the attachment of the screen material 2 to the roller tube 11. The spring assembly 9 allows the invention to automatically retract when the user opens or closes the window. The roller tube 11 is only able to retract properly when inserted into the mounting brackets 3. The mounting brackets 3 are securely attached to the automobile 19 using an outdoor strength two-sided adhesive tape 14. Two mounting brackets 3 are required for each roller tube 11, and only differ from one another by the shape of the opening each one has. Referring to FIG. 4, one bracket has a round opening 15 through the width, while the opposite bracket has a rectangular shape 16. The round opening 15 allows the round threaded shaft 6 to be inserted and secured by a nut 7. This allows the roller tube 11 to freely rotate 360 degrees, while the rectangular opening 16 allows the spring assembly 9 square shaft 10 to be inserted and locked into position allowing the spring to self-retract. The round threaded shaft 6 is secured to the cap 8, which fits snug inside the roller tube 11. The cap 8 positioned on the spring assembly 9 end has a rectangular opening, allowing the spring assembly 9 square shaft 10 to be inserted through. The screen material 2 has a re-enforcement strip 5 sewn to the edge on the bottom side of the screen that connects to the automobile's window 17. The re-enforcement strip 5 acts as a rub patch for where the mounting clips shown in FIG. 3, will rest when attaching the screen material 2 to the automobile's window 17. The re-enforcement strip 5 has two pockets 4 sewn on the bottom side of the screen. The pockets 4 allow the mounting clips shown in FIG. 3 to attach the screen 2 to the automobile's window 17 without affecting the existing method of opening and closing the window. Also shown in FIG. 3 is how the top handle and bottom handle, of each clip differ. The shorter handle will be known as the top, which will be resting against the re-enforcement strip 5 after installation is complete. The longer of the two handles, known as the bottom, will be able to swing open or closed. Referring to FIG. 3, mounting clip 12 is ready to be opened and inserted onto the pocket 4 of the screen 2, allowing the screen to attach to the automobile's window 17. The mounting clip 13 shows how the bottom handle can swing to the closed position. After the clip attaches the screen to the window, the bottom handle will swing forward to complete installation. This assures no part of the invention will interfere with any part of the automobile or its existing window system.

The outdoor retractable screen for automobile will deflect many objects from entering an open window 17 on any automobile 19. The screen material 2 will prevent most unwanted particles of matter or any act of mother-nature from directly entering the automobile's window. Many unwanted particles may be described as common debris falling from trees such as leaves, sticks, dirt, sap, but not limiting to other objects that may be in the air. While the vehicle is in motion, air currents may be forcibly entering the vehicle, and become a nuisance to the passengers. With the screen in its opened position, it will deflect and re-direct some or all air currents, therefore solving a nuisance to the passenger. Another act of mother-nature that the retractable screen will shield is rain. Dependant on how hard the rain may be, the screen will filter large drops of water and re-direct away from entering the window.

The invention will also act as a deterrent for theft. Leaving a window open with no protection leaves a certain sense of insecurity. With a shielding cover such as the retracting screen, an act of theft may be deterred by the automobile's window covering. Even though there are no physical characteristics of the invention that make it a security feature, the visualization of covering an open window will deter acts of theft.

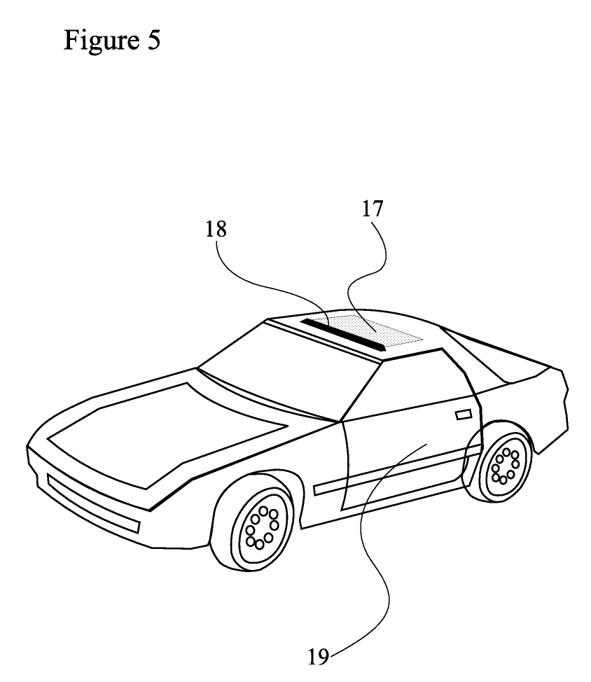

Once the invention is assembled and ready for use, the mounting brackets 3 are permanently attached to the vehicle. The roller tube 1 can be inserted or removed from the mounting brackets if necessary, however, intentions of the invention are to be permanently attached to the vehicle. When the invention is not desired by the user, the screen can be detached from the window with the two mounting clips shown in FIG. 3 and retracted to the stow-away position, allowing the window to be exposed. The invention is designed to be small enough in height, width, and length to allow it to secure and be able to use underneath a vehicle's rain/wind deflector 18. A vehicle's rain/wind deflector 18 is a common accessory for an automobile already in today's world. This deflector shields rain/wind from entering the window when the window is slightly opened. The deflector 18 will not shield rain/wind if the window is opened to its fullest capacity. This is where the retracting screen is most desired. Also, being designed small enough to be mounted underneath a standard rain/wind deflector 18 will shield the invention from direct exposure to sunlight and other damaging outdoor climates, while at the same time giving the retracting assembly a sleek, non-obvious look. The retracting screen will not be easily visible as it can be mounted underneath any existing rain/wind deflector 18 as shown in FIG. 5.

The invention can be used for any window on any automobile. Some other examples other than a car pictured in FIG. 5, can be a rear window on any SUV, hybrid, van, and many windows on RV's, but not limiting to any other type of automobile not listed.

I claim:

1.) An outdoor retractable screen for automobile used to shield some or all debris and acts of mother-nature from entering a vehicle's window comprising, a roller tube with spring assembly, mounting brackets, mounting clips, and a screen material.

2.) An outdoor retractable screen for automobile as in claim 1, wherein the dimensional size of the completed assembly is less than the dimensional size of a vehicle's rain/wind deflector, enabling the completed outdoor retractable screen for automobile to position itself discreetly underneath the rain/wind deflector.
